(19) United States
(12) Patent Application Publication
(10) Pub. No.: US 2021/0409100 A1
(43) Pub. Date: Dec. 30, 2021

(54) WIRELESS COMMUNICATION SYSTEM, WIRELESS SIGNAL EXTENDING APPARATUS AND METHOD OF THE SAME

(71) Applicant: Sigmastar Technology Ltd., Xia'men City (CN)

(72) Inventor: JIN-HUA FAN, Shenzhen City (CN)

(21) Appl. No.: 17/336,357

(22) Filed: Jun. 2, 2021

(30) Foreign Application Priority Data
Jun. 30, 2020 (CN) 202010617565.X

(51) Int. Cl. H04B 7/155; H04W 72/04; H04W 52/02

(52) U.S. Cl. CPC H04B 7/15507; H04W 84/12; H04W 52/0209; H04W 72/04

(57) ABSTRACT

The present invention discloses a wireless signal extending apparatus that includes a wireless signal transmission circuit and a processing circuit. The wireless signal transmission circuit only includes a single receiving circuit and a single transmission circuit. The processing circuit executes software or firmware executable commands to perform a wireless signal transmission method including steps outlined below. A first transmission channel between the wireless signal transmission circuit and a wireless network router that corresponds to a standard WiFi wireless communication protocol is controlled to perform communication during a plurality of router communication time periods. A second transmission channel between the wireless signal transmission circuit and a wireless network station that corresponds to a non-standard WiFi wireless communication protocol is controlled to perform communication during a plurality of gap time periods, wherein each of the gap time periods is located between neighboring two of the router communication time periods.

### CROSS-REFERENCE TO RELATED APPLICATION

This non-provisional application claims priority under 35 U.S.C. § 119(a) to Patent Application No. 202010617565.X filed in China, PR C on Jun. 30, 2020, the entire contents of which are hereby incorporated by reference.

### BACKGROUND OF THE INVENTION

### 1. Field of the Invention

The present invention relates to a wireless communication system, a wireless signal extending apparatus and a wireless signal extending method of the same.

### 2. Description of Related Art

In wireless network communication technology, the signal transmission between devices is limited by distance or obstacles therebetween. More specifically, the signal strength attenuates more when the distance between the devices are longer or when more the obstacles are presented between the devices. As a result, wireless signal extending apparatuses are often disposed in the wireless network to provide a relay function between two devices.

However, in order to process the communication with two terminal devices at the same time, two transceiver circuits are required in the wireless signal extending apparatus. As a result, the cost becomes higher. The wireless signal extending apparatus, that includes only one transceiver circuit and has thus a lower cost, is only able to process the communication of one device by using standard WiFi communication protocol in a single time period. The signal transmission of two terminal devices performed simultaneously can not be processed. Under such a condition, if the two terminal devices perform communication at the same time, the wireless signal extending apparatus may miss the signal of one of the terminal devices.

### SUMMARY OF THE INVENTION

In consideration of the problem of the prior art, an object of the present invention is to provide a wireless communication system, a wireless signal extending apparatus and a wireless signal extending method of the same.

The present invention discloses a wireless signal extending apparatus that includes a wireless signal transmission circuit and a processing circuit. The wireless signal transmission circuit only includes a single receiving circuit and a single transmission circuit. The processing circuit is electrically coupled to the wireless signal transmission circuit and is configured to execute a plurality of software or firmware executable commands to perform a wireless signal extending method. The wireless signal extending method includes the steps outlined below. A first transmission channel between the wireless signal transmission circuit and a wireless network router that corresponds to a standard WiFi wireless communication protocol is controlled to perform communication during a plurality of router communication time periods. A second transmission channel between the wireless signal transmission circuit and a wireless network station that corresponds to a non-standard WiFi wireless communication protocol is controlled to perform communication during a plurality of gap time periods, wherein each of the gap time periods is located between neighboring two of the router communication time periods.

The present invention also discloses a wireless signal extending method used in a wireless signal extending apparatus that includes the steps outlined below. A first transmission channel between a wireless signal transmission circuit and a wireless network router that corresponds to a standard WiFi wireless communication protocol is controlled to perform communication during a plurality of router communication time periods by a processing circuit, wherein the wireless signal transmission circuit only comprises a single receiving circuit and a single transmission circuit. A second transmission channel between the wireless signal transmission circuit and a wireless network station that corresponds to a non-standard WiFi wireless communication protocol is controlled to perform communication during a plurality of gap time periods by the processing circuit, wherein each one of the gap time periods is located between neighboring two of the router communication time periods.

The present invention further discloses a wireless communication system that includes a wireless network router, a wireless network station and a wireless signal extending apparatus. The wireless signal extending apparatus includes a wireless signal transmission circuit and a processing circuit. The wireless signal transmission circuit only includes a single receiving circuit and a single transmission circuit. The processing circuit is electrically coupled to the wireless signal transmission circuit and is configured to execute a plurality of software or firmware executable commands to perform a wireless signal extending method. The wireless signal extending method includes the steps outlined below. A first transmission channel between the wireless signal transmission circuit and the wireless network router that corresponds to a standard WiFi wireless communication protocol is controlled to perform communication during a plurality of router communication time periods. A second transmission channel between the wireless signal transmission circuit and the wireless network station that corresponds to a non-standard WiFi wireless communication protocol is controlled to perform communication during a plurality of gap time periods, wherein each one of the gap time periods is located between neighboring two of the router communication time periods.

To better describe the technical solution of the embodiments of the present invention, drawings involved in the description of the embodiments are introduced below. It is apparent that, the drawings in the description below represent merely some embodiments of the present invention, and other drawings apart from these drawings may also be obtained by a person skilled in the art without involving inventive skills.

### BRIEF DESCRIPTION OF THE DRAWINGS

FIG. 1 illustrates a circuit diagram of a wireless communication system according to an embodiment of the present invention.

FIG. 2 illustrates a flow chart of a wireless signal extending method according to an embodiment of the present invention.

FIG. 3 illustrates an operation timing diagram when the wireless signal extending apparatus performs communication according to an embodiment of the present invention.

### DETAILED DESCRIPTION OF THE PREFERRED EMBODIMENTS

An object of the present invention is to provide a wireless communication system, a wireless signal extending apparatus and a wireless signal extending method of the same to allow the wireless signal extending apparatus to perform communication effectively with the wireless network router and the wireless network station at the same time without missing data by using a low cost design.

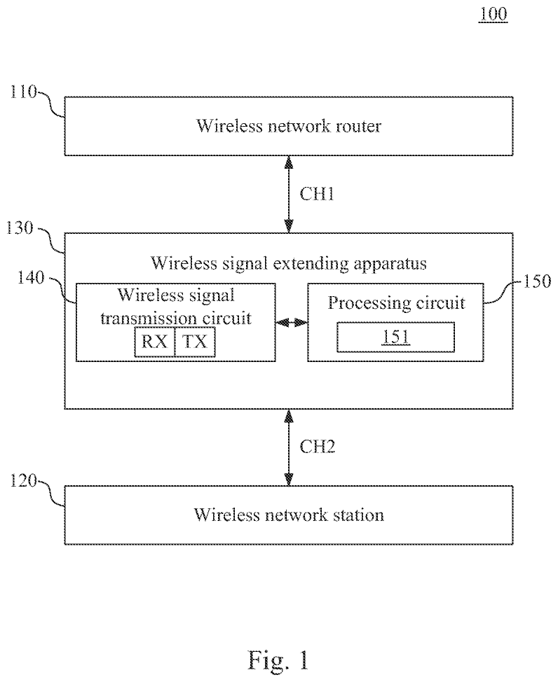

Reference is now made to FIG. 1. FIG. 1 illustrates a circuit diagram of a wireless communication system 100 according to an embodiment of the present invention. The wireless communication system 100 includes a wireless network router 110, a wireless network station 120 and a wireless signal extending apparatus 130.

The wireless network router 110 is configured to provide stable network signals, and the wireless network station 120 is configured to access the network through the wireless network router 110. In an embodiment, the wireless network station 120 and the wireless network router 110 may have a longer distance therebetween, or an obstacle such as a wall may be presented therebetween to attenuate the signals. The wireless network station 120 thus is not able to access the network from the wireless network router 110 efficiently. Under such a condition, the disposition of the wireless signal extending apparatus 130 provides a relay function such that the wireless network station 120 and the wireless network router 110 perform communication more efficiently through the wireless signal extending apparatus 130.

In a practical example, the wireless network station 120 can be such as, but not limited to an IP camera. After retrieving the image data, the wireless network station 120 can transmit the image data to the wireless network router 110 through the wireless signal extending apparatus 130. The wireless network router 110 may further transmit the image data to a remote server to perform processing or storage. However, the application of the present invention is not limited thereto.

As illustrated in FIG. 1, the wireless signal extending apparatus 130 includes a wireless signal transmission circuit 140 and a processing circuit 150.

The wireless signal transmission circuit 140 only includes a single receiving circuit RX and a single transmission circuit TX. The receiving circuit RX is configured to receive wireless signals. The transmission circuit TX is configured to transmit wireless signals. As a result, during a single time period, the wireless signal transmission circuit 140 performs data transmission by using only one wireless network channel.

The processing circuit 150 is electrically coupled to the wireless signal transmission circuit 140. The processing circuit 140 may include one or a plurality of microprocessors to execute software or firmware executable commands 151 to perform the function of the wireless signal extending apparatus 130. More specifically, the processing circuit 150 can retrieve the software or firmware executable commands 151 from a storage module (not illustrated) in the wireless signal extending apparatus 130, in which the software or firmware executable commands 151 include such as, but not limited to the firmware/driver of the wireless signal transmission circuit 140 or other commands for operating and controlling the wireless signal transmission circuit 140. The wireless signal transmission circuit 140 thus can be operated and controlled to accomplish the function of relaying and extending the wireless signals.

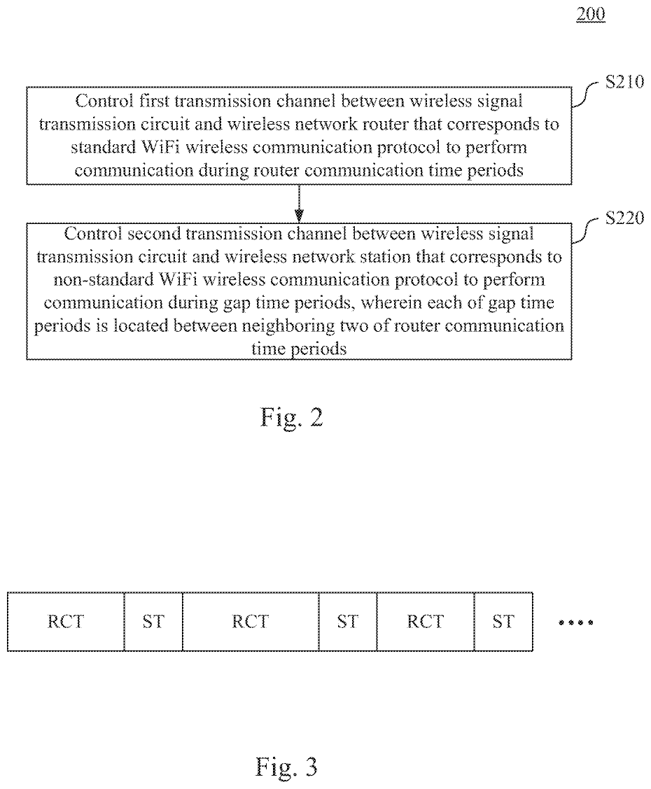

Reference is now made to FIG. 2 and FIG. 3 at the same time. The detail function of the wireless signal extending apparatus 130 is described in the following paragraphs in accompany with FIG. 1, FIG. 2 and FIG. 3.

FIG. 2 illustrates a flow chart of a wireless signal extending method 200 according to an embodiment of the present invention. FIG. 3 illustrates an operation timing diagram when the wireless signal extending apparatus 130 performs communication according to an embodiment of the present invention. The wireless signal extending method 200 can be used in the wireless signal extending apparatus 130 illustrated in FIG. 1. The wireless signal extending method 200, as illustrated in FIG. 2, includes the steps outlined below.

In step S210, a first transmission channel CH1 between the wireless signal transmission circuit 140 and the wireless network router 110 that corresponds to a standard WiFi wireless communication protocol is controlled to perform communication during a plurality of router communication time periods RCT illustrated in FIG. 3.

In an embodiment, the standard WiFi wireless communication protocol described above is IEEE 802.11 communication protocol. More specifically, the standard WiFi wireless communication protocol can be such as, but not limited to the communication protocols of IEEE 802.11b, 802.11g and 802.11n.

In step S220, a second transmission channel CH2 between the wireless signal transmission circuit 140 and the wireless network station 120 that corresponds to a non-standard WiFi wireless communication protocol is controlled to perform communication during a plurality of gap time periods ST illustrated in FIG. 3. Each of the gap time periods ST is located between neighboring two of the router communication time periods RCT.

In an embodiment, each of the gap time periods is a power-saving sleep time period, and the duration of the power-saving sleep time period ranges from 100 milliseconds to 1 second. Further, in an embodiment, the processing circuit 150 is further configured to control the wireless signal transmission circuit 140 to transmit a first request to the wireless network router 110 to terminate the router communication time periods and subsequently transmit a second request to the wireless network station 120 to enter the gap time periods.

Further, the non-standard WiFi wireless communication protocol can be a private communication protocol established between the wireless signal transmission circuit 140 and the wireless network station 120. As a result, besides performing communication with the wireless network router 110 in the router communication time periods, the wireless signal transmission circuit 140 can use the gap time periods therebetween to perform communication with the wireless network station 120 by switching from the first transmission channel CH1 to the second transmission channel CH2. Under such a condition, the wireless network station 120 performs communication with the wireless signal transmission circuit 140 only in the gap time periods to guarantee that the wireless signal transmission circuit 140 does not miss the data transmitted by the wireless network station 120.

In some approaches, the wireless signal extending apparatus 130 needs to include two receiving circuits and two transmission circuits to perform communication with the wireless network router 110 and the wireless network station 120 simultaneously, in which the cost is higher. Under the condition that the wireless signal extending apparatus 130 only includes a single receiving circuit and a single transmission circuit, when the wireless signal extending apparatus 130 performs communication with the wireless network router 110 and the wireless network station 120 according to only the standard WiFi wireless communication protocol, the wireless signal extending apparatus 130 may be occupied by the communication performed with one of the two terminal devices, may be not able to receive the data from the other one of the two terminal devices at the same time and may thus miss the data.

As a result, the wireless signal extending apparatus 130 of the present invention can perform communication with the wireless network station 120 during the gap time periods by using another channel, which is free from crowded communication and interference, under the condition that the communication performed with the wireless network router 110 using the standard WiFi wireless communication protocol is not affected. Not only such a design can be compatible with the current WiFi technology, the communication can be performed with the wireless network router 110 and the wireless network station 120 at the same time with only a single receiving circuit and a single transmission circuit without additional cost.

It is appreciated that the embodiments described above are merely an example. In other embodiments, it should be appreciated that many modifications and changes may be made by those of ordinary skill in the art without departing, from the spirit of the invention.

In summary, the wireless communication system, the wireless signal extending apparatus and the wireless signal extending method of the same allows the wireless signal extending apparatus to perform communication with the wireless network router and the wireless network station at the same time without missing data by using a low cost design.

The aforementioned descriptions represent merely the preferred embodiments of the present invention, without any intention to limit the scope of the present invention thereto. Various equivalent changes, alterations, or modifications based on the claims of present invention are all consequently viewed as being embraced by the scope of the present invention.

What is claimed is:

1. A wireless signal extending apparatus, comprising:
a wireless signal transmission circuit only comprising a single receiving circuit and a single transmission circuit; and
a processing circuit electrically coupled to the wireless signal transmission circuit and configured to execute a plurality of software or firmware executable commands to perform a wireless signal extending method, wherein the wireless signal extending method comprises:
controlling a first transmission channel between the wireless signal transmission circuit and a wireless network router that corresponds to a standard WiFi wireless communication protocol to perform communication during a plurality of router communication time periods; and
controlling a second transmission channel between the wireless signal transmission circuit and a wireless network station that corresponds to a non-standard WiFi wireless communication protocol to perform communication during a plurality of gap time periods, wherein each of the gap time periods is located between neighboring two of the router communication time periods.

2. The wireless signal extending apparatus of claim 1, wherein each of the gap time periods is a power-saving sleep time period, and a duration of the power-saving sleep time period ranges from 100 milliseconds to 1 second.

3. The wireless signal extending apparatus of claim 1, wherein the standard WiFi wireless communication protocol is IEEE 802.11 communication protocol.

4. The wireless signal extending apparatus of claim 1, wherein the processing circuit is further configured to control the wireless signal transmission circuit to transmit a first request to the wireless network router to terminate the router communication time periods and transmit a second request to the wireless network station to enter the gap time periods.

5. A wireless signal extending method used in a wireless signal extending apparatus, comprising:
controlling a first transmission channel between a wireless signal transmission circuit and a wireless network router that corresponds to a standard WiFi wireless communication protocol to perform communication during a plurality of router communication time periods by a processing circuit, wherein the wireless signal transmission circuit only comprises a single receiving circuit and a single transmission circuit; and
controlling a second transmission channel between the wireless signal transmission circuit and a wireless network station that corresponds to a non-standard WiFi wireless communication protocol to perform communication during a plurality of gap time periods by the processing circuit, wherein each of the gap time periods is located between neighboring two of the router communication time periods.

6. The wireless signal extending method of claim 5, wherein each of the gap time periods is a power-saving sleep time period, and a duration of the power-saving sleep time period ranges from 100 milliseconds to 1 second.

7. The wireless signal extending method of claim 5, wherein the standard WiFi wireless communication protocol is IEEE 802.11 communication protocol.

8. The wireless signal extending method of claim 5, further comprising:
controlling the wireless signal transmission circuit to transmit a first request to the wireless network router to terminate the router communication time periods and transmit a second request to the wireless network station to enter the gap time periods by the processing circuit.

9. A wireless communication system, comprising:
a wireless network router;
a wireless network station; and
a wireless signal extending apparatus comprising:
a wireless signal transmission circuit only comprising a single receiving circuit and a single transmission circuit; and
a processing circuit electrically coupled to the wireless signal transmission circuit and configured to execute a plurality of software or firmware executable commands to perform a wireless signal extending method, wherein the wireless signal extending method comprises:
controlling a first transmission channel between the wireless signal transmission circuit and the wireless network router that corresponds to a standard WiFi wireless communication protocol to perform communication during a plurality of router communication time periods; and
controlling a second transmission channel between the wireless signal transmission circuit and the wireless network station that corresponds to a non-standard WiFi wireless communication protocol to perform communication during a plurality of gap time periods, wherein each of the gap time periods is located between neighboring two of the router communication time periods.

10. The wireless communication system of claim 9, wherein each of the gap time periods is a power-saving sleep time period, and a duration of the power-saving sleep time period ranges from 100 milliseconds to 1 second.

11. The wireless communication system of claim 9, wherein the standard WiFi wireless communication protocol is IEEE 802.11 communication protocol.

12. The wireless communication system of claim 9, wherein the processing circuit is further configured to control the wireless signal transmission circuit to transmit a first request to the wireless network router to terminate the router communication time periods and transmit a second request to the wireless network station to enter the gap time periods.
